(19) United States
(12) Patent Application Publication
(10) Pub. No.: US 2020/0021462 A1
(43) Pub. Date: Jan. 16, 2020

(54) DUAL-NETWORK SPLITTER

(71) Applicant: PPC BROADBAND, INC., EAST SYRACUSE, NY (US)

(72) Inventor: Paul Bailey, Camillus, NY (US)

(21) Appl. No.: 16/248,397

(22) Filed: Jan. 15, 2019

Related U.S. Application Data
(60) Provisional application No. 62/697,454, filed on Jul. 13, 2018.

(51) Int. Cl. H04L 12/46; H04L 5/08

(52) U.S. Cl. CPC H04L 12/46; H04L 5/08

(57) ABSTRACT

A dual-network splitter includes an input port configured to transmit and receive signals in a first frequency band. The dual-network splitter also includes one or more dual-network output ports configured to transmit and receive the signals in the first frequency band and signals in a second frequency band. The dual-network splitter also includes one or more single-network output ports configured to transmit and receive the signals in the second frequency band but not in the first frequency band.

### CROSS-REFERENCE TO RELATED APPLICATIONS

This application claims priority to U.S. Provisional Patent Application No. 62/619,268, filed on Jan. 19, 2018, and U.S. Provisional Patent Application No. 62/697,454, filed on Jul. 13, 2018. The entirety of both applications is incorporated by reference herein.

### BACKGROUND

A dual-network splitter is a splitter device that may be used to couple two networks, such as a cable television (CATV) network and a multimedia over coax alliance (MoCA) network. The CATV network is within a frequency band from about 5 MHz to about 1002 MHz, and the MoCA network is within a frequency band from about 1125 MHz to about 1675 MHz. The dual-network splitter may treat each network independently, gaining benefits from frequency band optimized circuit elements. The dual-network splitter may pass CATV signals and MOCA signals through a common element, such as a broadband ferrite splitter. However, such dual-network splitters oftentimes have challenges that result in performance compromises such as insertion loss, isolation, or return loss.

### SUMMARY

A dual-network splitter is disclosed. The dual-network splitter includes an input port configured to transmit and receive signals in a first frequency band. The dual-network splitter also includes one or more dual-network output ports configured to transmit and receive the signals in the first frequency band and signals in a second frequency band. The dual-network splitter also includes one or more single-network output ports configured to transmit and receive the signals in the second frequency band. The dual-network splitter also includes a first splitter connected to the input port and configured to have the signals in the first frequency band pass therethrough. The dual-network splitter also includes a second splitter connected to the first splitter and configured to have the signals in the first frequency band pass therethrough. The dual-network splitter also includes a first dual-network filter connected to the first splitter and to a first of the dual-network output ports. The first dual-network filter is configured to transmit the signals in the first and second frequency bands to the first of the dual-network output ports and to receive the signals in the first and second frequency bands from the first of the dual-network output ports. The first dual-network filter is configured to transmit the signals in the first frequency band to the first splitter and to receive the signals in the first frequency band from the first splitter. The dual-network splitter also includes a second dual-network filter connected to the second splitter and to a second of the dual-network output ports. The second dual-network filter is configured to transmit the signals in the first and second frequency bands to the second of the dual-network output ports and to receive the signals in the first and second frequency bands from the second of the dual-network output ports. The second dual-network filter is configured to transmit the signals in the first frequency band to the second splitter and to receive the signals in the first frequency band from the second splitter. The dual-network splitter also includes a third dual-network filter connected to the second splitter and to a third of the dual-network output ports. The third dual-network filter is configured to transmit the signals in the first and second frequency bands to the third of the dual-network output ports and to receive the signals in the first and second frequency bands from the third of the dual-network output ports. The third dual-network filter is configured to transmit the signals in the first frequency band to the second splitter and to receive the signals in the first frequency band from the second splitter. The dual-network splitter also includes a third splitter connected to the first dual-network filter, the second dual-network filter, the third dual-network filter, and the one or more single-network output ports. The third splitter is configured to have the signals in the second frequency band pass therethrough.

In another embodiment, the dual-network splitter includes an input port configured to transmit and receive signals in a first frequency band. The dual-network splitter also includes one or more dual-network output ports configured to transmit and receive the signals in the first frequency band and signals in a second frequency band. The dual-network splitter also includes one or more single-network output ports configured to transmit and receive the signals in the second frequency band but not in the first frequency band.

In another embodiment, the dual-network splitter includes an input port configured to transmit and receive signals in a first frequency band but not in a second frequency band. The dual-network splitter also includes one or more dual-network output ports configured to transmit and receive the signals in the first frequency band and the signals in the second frequency band. The dual-network splitter also includes one or more single-network output ports configured to transmit and receive the signals in the second frequency band but not in the first frequency band. The dual-network splitter also includes a first splitter connected to the input port and configured to have the signals in the first frequency band pass therethrough. The dual-network splitter also includes a second splitter connected to the first splitter and configured to have the signals in the first frequency band pass therethrough. The dual-network splitter also includes a third splitter connected to the first splitter, the second splitter, and the one or more single-network output ports. The third splitter is configured to have the signals in the second frequency band pass therethrough.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 illustrates a schematic view of an example of a dual-network splitter including a 3-way access/home network ferrite splitter and a 4-way resistive in-home network splitter, according to an embodiment.

FIG. 2 illustrates a schematic view of an example of a dual-network filter (DNF), according to an embodiment.

FIG. 3A illustrates a schematic view of an example of a DNF including a low-pass filter (LPF) to constrain the in-home network to one or more splitters (only one is shown), according to an embodiment.

FIG. 3B illustrates a schematic view of another example of a DNF including the LPF in a different location to also constrain the in-home network to one or more splitters (only one is shown), according to an embodiment.

FIG. 4 illustrates a schematic view of an example of a DNF including a LPF and a high-pass filter (HPF), according to an embodiment.

FIG. 5 illustrates a schematic view of an example of a DNF constructed as a diplex filter, according to an embodiment.

FIG. 6 illustrates a schematic view of an example of a dual-network splitter including a 3-way access network ferrite splitter and a 6-way resistive in-home network splitter, according to an embodiment.

FIG. 7 illustrates a schematic view of an example of another dual-network splitter including a 3-way access network ferrite splitter and a 6-way resistive in-home network splitter, according to an embodiment.

FIG. 8 illustrates a schematic view of an example of yet another dual-network splitter including a 3-way access network ferrite splitter and a 6-way resistive in-home network splitter, according to an embodiment.

FIG. 9 illustrates a schematic view of an example of yet another dual-network splitter including a 3-way access network ferrite splitter and a 6-way resistive in-home network splitter, according to an embodiment.

FIG. 10 illustrates a schematic view of an example of yet another dual-network splitter including a 3-way access network ferrite splitter and a 2-way resistive in-home network splitter, according to an embodiment.

FIG. 11 illustrates a schematic view of an example of yet another dual-network splitter, according to an embodiment.

### DETAILED DESCRIPTION

The present disclosure relates to dual-network splitters and, more particularly, to positioning various filters to isolate two networks (e.g., the CATV and MoCA networks) as much as possible. Dual network filters (DNFs) may include low-pass filters (LPFs), high-pass filters (HPFs), and/or diplex filters. As the degree of isolation between the networks increases, so too does the level of optimization of the circuit elements and performance. In one example, a LPF and a broadband ferrite splitter may be used for the CATV network, and a HPF with a resistive splitter may be used for the MoCA (e.g., in-home) network. This may provide beneficial tradeoffs for many electrical parameters, such as decreasing CATV insertion loss between the input port and access ports, decreasing MoCA isolation between in-home ports, and increasing isolation between the access and in-home networks. This may lead to less complex, dominantly passive, and more reliable networks, which have less failure modes by decreasing the need for amplifiers, and increased SNR by minimizing ingress of upstream noise. The coupling and isolation may occur at common nodes closer to the ports where one or more filters(s) provide the network-to-network isolation. The number of components (e.g., filters, splitters, and ports) that are common to both networks is minimized.

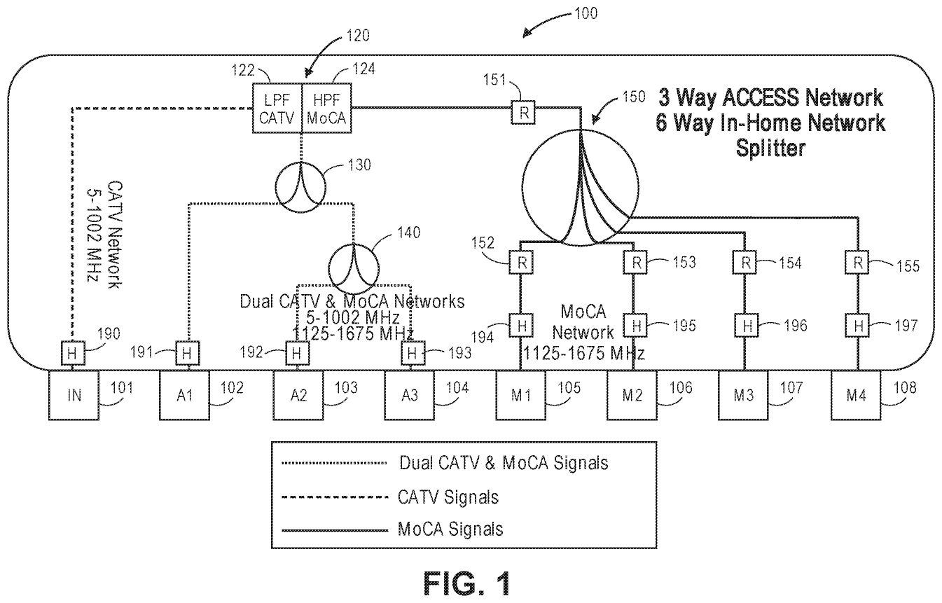

FIG. 1 illustrates a schematic view of an example of a dual-network splitter 100 including a 3-way access/home network ferrite splitter and a 4-way resistive in-home network splitter, according to an embodiment. The dual-network splitter 100 may have the input or coupling resistance minimized or removed for reduced MoCA loss and a HPF at each output port for low frequency noise rejection.

The dual-network splitter 100 may include an input port 101, one or more dual-network output ports (three are shown: 102-104), and one or more single-network output ports (four are shown: 105-108). The dual-network output ports 102-104 are in common with both the CATV and MoCA networks, and the single-network output ports 105-108 are only in one network (e.g., the MoCA network). In other words, the dual-network output ports 102-104 may pass signals in the CATV frequency band and the MoCA frequency band, and the single-network output ports 105-108 may pass signals in the MoCA frequency band but not in the CATV frequency band. As a result, the dual-network splitter 100 provides a more robust network with greater decoupling of the CATV and MoCA networks.

A diplexer 120 may be connected to the input port 101. More particularly, a LPF 122 of the diplexer 120 may be connected to the input port 101. A first (e.g., a two-way) splitter 130 may have a common port connected to the common port of the diplexer 120. The first splitter 130 may also have a first leg connected to the first dual-network output port 102 and a second leg connected to a common port of a second (e.g., a two-way) splitter 140. The second splitter 140 may have a first leg connected to the second dual-network output port 103 and a second leg connected to the third dual-network output port 104. The first and second splitters 130, 140 may be ferrite splitters. The splitters 130 and 140 facilitate the extension of dual-network ports and may be extended with additional splitters or omitted should only a single dual network port be required.

A HPF 124 of the diplexer 120 may be connected to a third (e.g., a four-way) splitter 150. The third splitter 150 may be a resistive splitter. The four legs of the third splitter 150 may be connected to the four single-network output ports 105-108, respectively. A first resistor 151 may be connected between the diplexer 120 and the third splitter 150. Additionally, a resistor 152-155 may be connected between the third splitter 150 and each of the MoCA-only output ports 105-108. The third splitter 150 split count may be increased or decreased to provide the number of single network ports required. HPFs 190-197 are low-order high-voltage DC-blocking and/or surge protection elements.

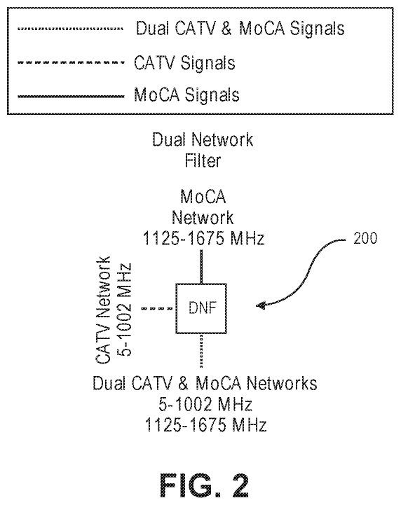

FIG. 2 illustrates a schematic view of an example of a dual-network filter (DNF) 200, according to an embodiment. The DNF 200 combines or splits signals from two networks (e.g., the CATV network and the MoCA network). The DNF 200 includes a first port that is in the CATV frequency band and thus only transmits and/or receives CATV signals. The DNF 200 also includes a second port that is in the MoCA frequency band and thus only transmits and/or receives MoCA signals. The DNF 200 also includes a third port that is in both networks and thus may transmit and/or receive CATV and MoCA signals.

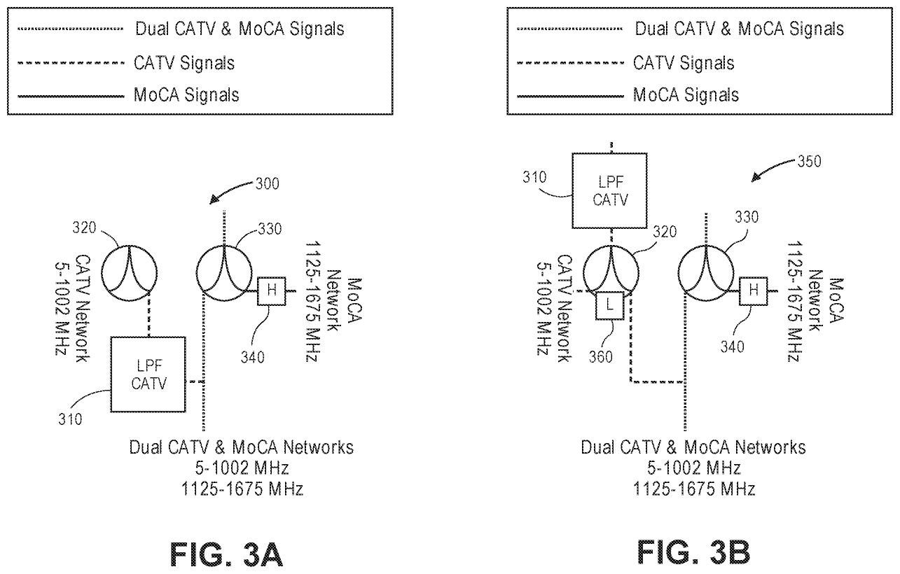

FIG. 3A illustrates a schematic view of an example of a DNF 300 including a LPF 310 and a low-order HPF 340, according to an embodiment. The DNF 300 is constructed with the LPF 310 and low-order HPF 340 that regulate the signal flow by coupling or decoupling signals from two networks (e.g., the CATV and MoCA networks) amongst a pair of splitters 320, 330. As shown, signals in two networks may be introduced to the LPF 310. The LPF 310 may allow the signals below a first threshold frequency (i.e., the CATV signals) to pass therethrough to a first (e.g., two-way) splitter 320, while preventing signals above the first threshold frequency (i.e., the MoCA signals) from passing therethrough.

The signals above the first threshold frequency may pass through a second (e.g., two-way) splitter 330 and through a HPF 340. The HPF 340 may prevent signals below a second threshold frequency (i.e., the CATV signals) from passing therethrough. In at least one embodiment, the LPF 310 may have a greater order than the HPF 340. For example, the LPF 310 may be a 9^{th} order, and the HPF 340 may be a 3^{rd} order or 5^{th} order. In addition, the LPF 310 and the HPF 340 may not be directly connected. In other words, they may have circuitry (e.g., second splitter 330) positioned between them.

FIG. 3B illustrates a schematic view of another example of a DNF 350 including the LPF 310 in a different location, according to an embodiment. Rather than having the LPF 310 connected to the leg of the first splitter 320, as in FIG. 3A, in FIG. 3B, the LPF 310 is connected to the common port of the first splitter 320. In addition, the isolation path of first splitter 320 may include a second LPF 360. As a result, the CATV signals pass while the MoCA signals are isolated from the input and first output of splitter 320. The MoCA signals may, as in FIG. 3A, travel through the second splitter 330 and the HPF 340. Both CATV and MoCA signals may pass bi-directionally through the second splitter's 330 first output to the input.

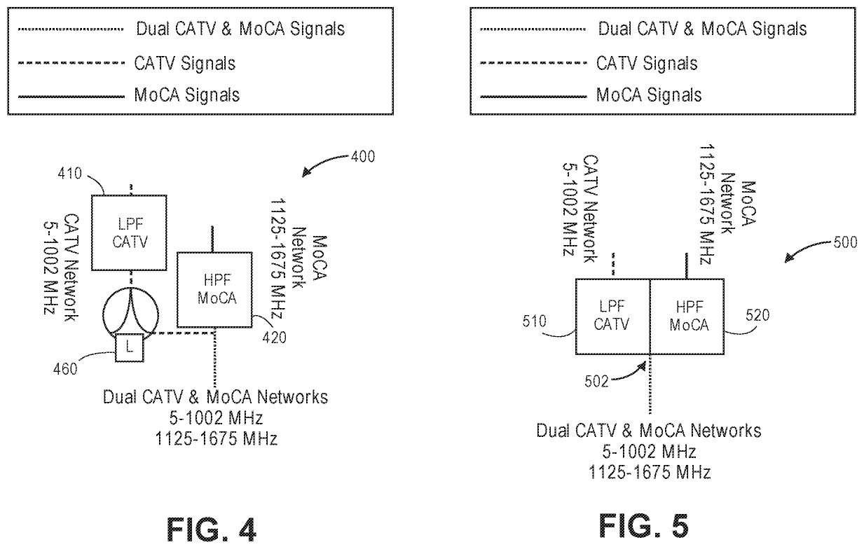

FIG. 4 illustrates a schematic view of an example of a DNF 400 including a LPF 410 and a HPF 420, according to an embodiment. The LPF 410 and the HPF 420 may be or include sub (i.e., low-order) filters that combine or split signals from two networks (e.g., the CATV network and the MoCA network). FIG. 4 may be similar to FIG. 3B, except that the second splitter 330 and the HPF 340 in FIG. 3B have been replaced with the HPF 420 in FIG. 4.

FIG. 5 illustrates a schematic view of an example of a DNF 500 constructed as a diplex filter, according to an embodiment. The DNF 500 may combine or split signals from two networks (e.g., the CATV network and the MoCA network). As shown, signals in the CATV and MoCA networks may be transmitted to the common port 502 of the DNF 500. The LPF 510 may allow the CATV signals to travel therethrough while preventing the MoCA signals from travelling therethrough. The HPF 520 may allow the MoCA signals to travel therethrough while preventing the CATV signals from travelling therethrough.

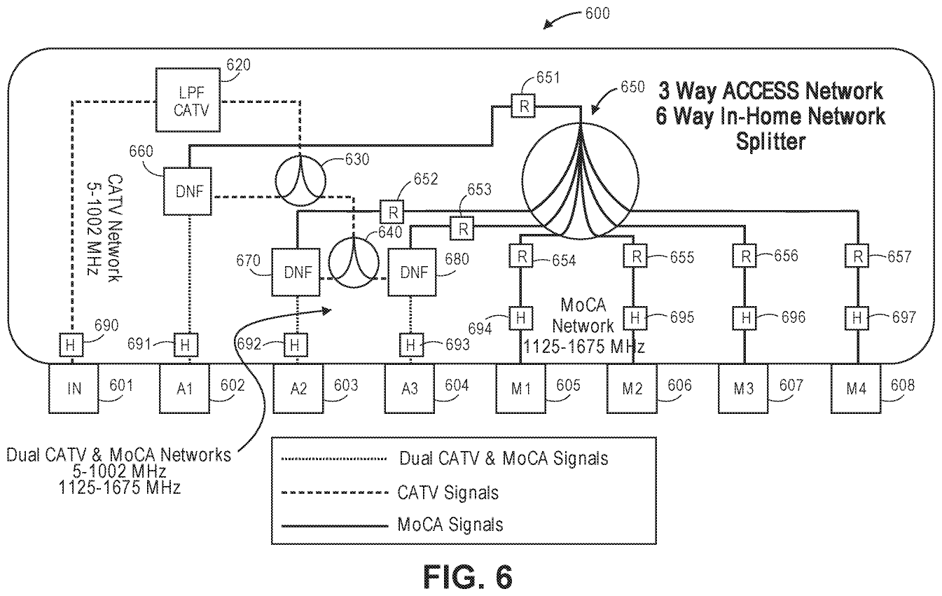

FIG. 6 illustrates a schematic view of an example of a dual-network splitter 600, according to an embodiment. The dual-network splitter 600 may be similar to the dual-network splitter 100 in FIG. 1. For example, the dual-network splitter 600 may include an input port 601, one or more dual-network output ports (three are shown: 602-604), and one or more single-network output ports (four are shown: 605-608). The dual-network splitter 600 may also include a first (e.g., two-way) splitter 630, a second (e.g., two-way) splitter 640, and a third (e.g., six-way) splitter 650.

A point of entry (POE) LPF 620 may be connected to and positioned between the input port 601 and the first splitter 630. A first DNF 660 may be connected to the first dual-network output port 602, the (first leg of the) first splitter 630, and the (common port of the) third splitter 650. A second DNF 670 may be connected to the second dual-network output port 603, the (first leg of the) second splitter 640, and (one of the legs of) the third splitter 650. A third DNF 680 may be connected to the third common dual-network port 604, the (second leg of the) second splitter 640, and (one of the legs of) the third splitter 650. The DNFs 660, 670, 680 may be or include any of the DNFs described above with reference to FIGS. 2, 3A, 3B, 4, and 5. Resistors 651-657 may also be connected between the DNFs 660, 670, 680 and the third splitter 650 and between the third splitter 650 and the MoCA-only output ports 605-608. The HPFs 690-697 are low-order, high-voltage, DC-blocking and/or surge protection elements. The benefit of the dual-network splitter 600 over that of the splitter 100 is that the dual-network coupling/decoupling points have been moved closer to the dual-network ports, providing greater isolation between the two networks and improved in-band performance within each network due to optimized single network designs.

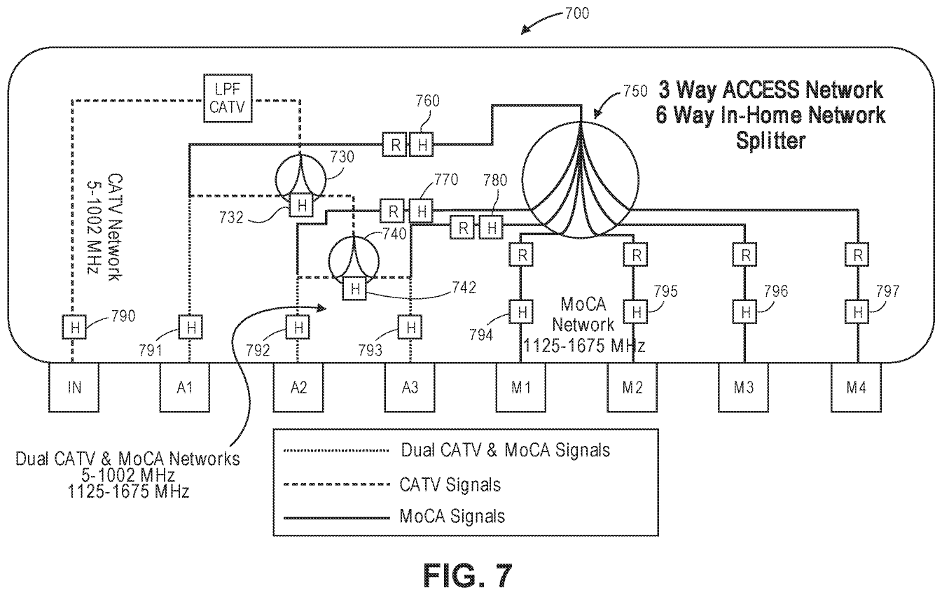

FIG. 7 illustrates a schematic view of an example of another dual-network splitter 700, according to an embodiment. The dual-network splitter 700 may be similar to the dual-network splitter 600, except the DNFs 660, 670, 680 may be omitted. In addition, the isolation paths of the first and second splitters 730, 740 may include low-order HPFs 732,742. Moreover, low-order HPFs 760, 770, 780 may also be connected to the input of the third splitter 750. The HPFs 732, 742, 760, 770, 780 may be low (e.g., 3^{rd} or 5^{th}) order. The HPFs 790-797 are low-order, high-voltage, DC-blocking and/or surge protection elements. The benefit of splitter 700 over the splitter 600 is that the low-order, HPFs are simpler in design than the DNF, which may be a higher order diplex filter.

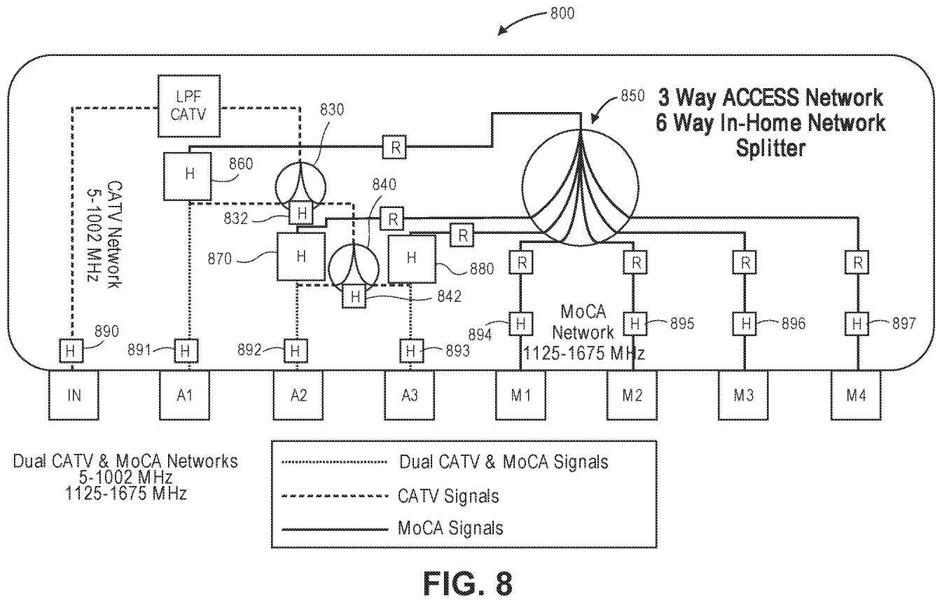

FIG. 8 illustrates a schematic view of an example of yet another dual-network splitter 800, according to an embodiment. The dual-network splitter 800 may be similar to the dual-network splitter 700, except the HPFs 860, 870, 880 are repositioned on the dual-network port side of the resistors. In addition, low-order (e.g., 3^{rd} or 5^{th} order) HPFs 832, 842 are placed in the isolation paths of the first and second splitters 830, 840. The first and second splitters 830, 840 may be ferrite splitters. The HPFs 890-897 are low-order, high-voltage, DC-blocking and/or surge protection elements. FIG. 8 simply shows the versatility of circuit design with substantially the same results.

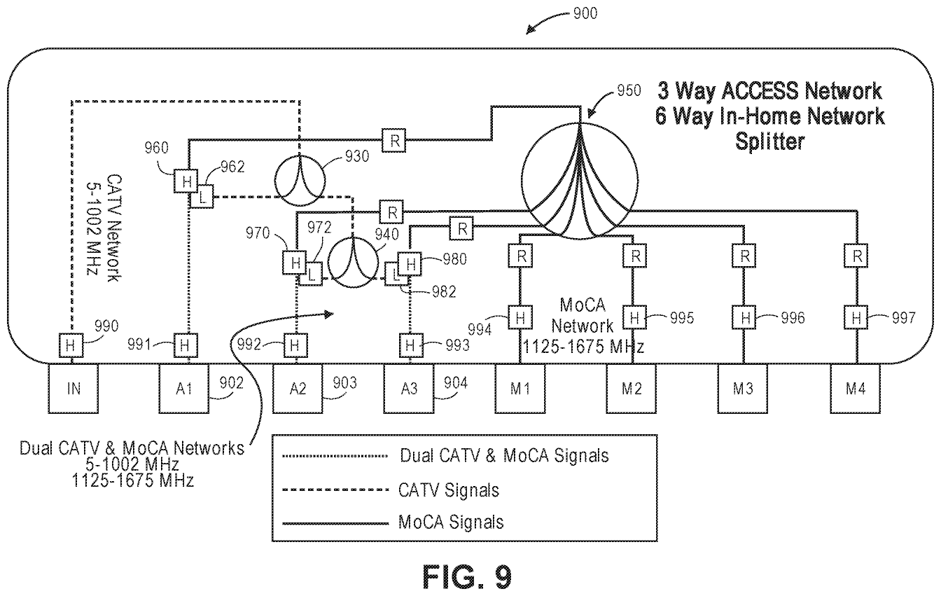

FIG. 9 illustrates a schematic view of an example of yet another dual-network splitter 900, according to an embodiment. The dual-network splitter 900 may be similar to the dual-network splitter 800, except that the HPFs 860, 870, 880 may instead be replaced with low-order (e.g., 3^{rd}, 5^{th}, or 7^{th} order) diplex filters, each including a low-order HPF 960, 970, 980 and a low-order LPF 962, 972, 982. Thus, the diplex filters are positioned between the dual-network output ports 902-904 and the splitters 930, 940 (i.e., at the intercept). These diplexers combined with the inherent insertion loss of the splitters provide sufficient isolation to omit the use of a POE LPF at the input side of splitter 930. As a result, signals in the MoCA frequency band may not pass through the first and second splitters 930, 940. Instead, the signals in the MoCA frequency band may pass through the resistive network. This may help to minimize the in-band MoCA notches induced by the non-linear ferrite splitters and reflections from the POE LPF if used at the input of 930. In addition, no HPFs are required in the isolation paths of the first and second splitters 930, 940. The HPFs 990-997 are low-order, high-voltage, DC-blocking and/or surge protection elements.

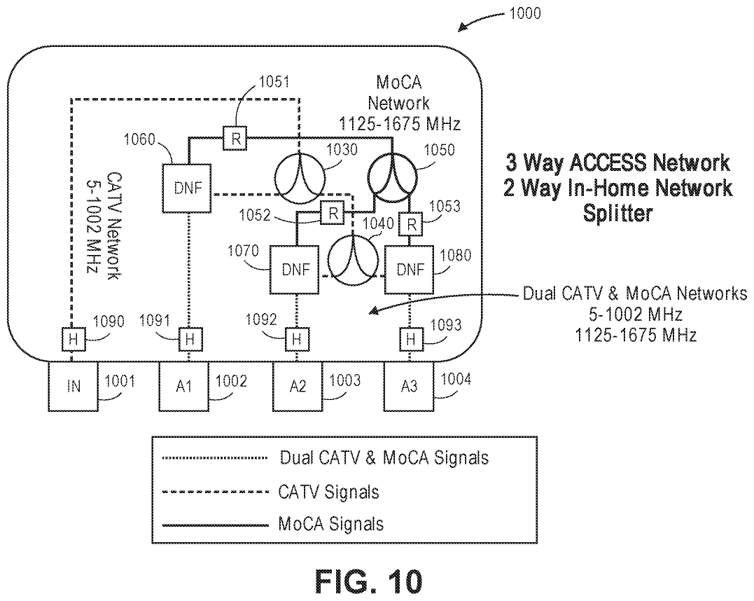

FIG. 10 illustrates a schematic view of an example of yet another dual-network splitter 1000, according to an embodiment. The dual-network splitter 1000 may include an input port 1001 and one or more dual-network output ports (three are shown: 1002-1004). The dual-network splitter 1000 may also include a first (e.g., two-way) splitter 1030, a second (e.g., two-way) splitter 1040, and a third (e.g., two-way) splitter 1050. The POE LPF may be omitted.

A first DNF 1060 may be connected to the first dual-network output port 1002, the (first leg of the) first splitter 1030, and the (common port of the) third splitter 1050. A second DNF 1070 may be connected to the second dual-network output port 1003, the (first leg of the) second splitter 1040, and (the first leg of) the third splitter 1050. A third DNF 1080 may be connected to the third dual-network output port 1004, the (second leg of the) second splitter 1040, and (the second leg of) the third splitter 1050. The DNFs 1060, 1070, 1080 may be or include any of the DNFs described above with reference to FIGS. 2, 3A, 3B, 4, and 5. For example, the DNFs 1060, 1070, 1080 may be or include dual-network diplex filters. In addition, resistors 1051-1053 may be connected to and positioned between the DNFs 1060, 1070, 1080 and the third splitter 1050.

In this embodiment, only the CATV frequency band (not the MoCA frequency band) has access through the input port 1001. Each of the dual-network output ports 1002-1004 are common to both networks. The DNFs 1060, 1070, 1080 may route the MoCA signals through the resistive network and route the CATV signals through the splitters 1030, 1040 and back to the input port 1001. The HPFs 1090-1093 are low-order, high-voltage, DC-blocking and/or surge protection elements.

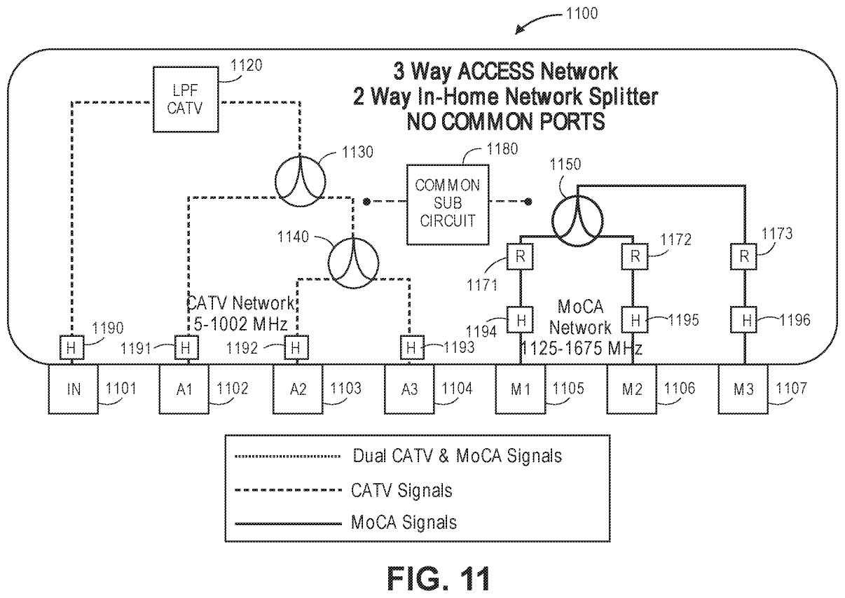

FIG. 11 illustrates a schematic view of an example of yet another dual-network splitter 1100, according to an embodiment. The dual-network splitter 1100 may include an input port 1101, one or more first (e.g., CATV network) output ports (three are shown: 1102-1104), and one or more second (e.g., MoCA network) output ports (three are shown: 1105-1107). An optional POE LPF 1120 may be connected to the input port 1101 and to a common port of a first (e.g., two-way) splitter 1130. A first leg of the first splitter 1130 is connected to the first CATV network output port 1102, and a second leg of the first splitter 1130 is connected to a second (e.g., two-way) splitter 1140. A first leg of the second splitter 1140 is connected to the second CATV network output port 1103, and a second leg of the second splitter 1140 is connected to the third CATV network output port 1104. Only the CATV frequency band has access through the input port 1101.

The dual-network splitter 1100 also includes a third 3-way resistive splitter 1150 having three legs connected to three MoCA output ports 1105-1107. A first resistor 1171 may be connected between the third splitter 1150 and the first MoCA output port 1105. A second resistor 1172 may be connected between the third splitter 1150 and the second MoCA output port 1106. A third resistor 1173 may be connected between the third splitter 1150 and the third MoCA output port 1107.

There may be no common nodes or outputs. A common sub-circuit 1180 may connect the CATV portion and the MoCA portion of the dual-network splitter 1100. The sub-circuit 1180 is the only common element. The sub-circuit 1180 may be or include a control or detection circuit for monitoring ports for automated port termination. The HPFs 1190-1196 are low-order, high-voltage, DC-blocking and/or surge protection elements.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. The present disclosure is not to be limited in terms of the particular embodiments described in this application, which are intended as illustrations of various aspects. Many modifications and variations can be made without departing from its spirit and scope, as will be apparent to those skilled in the art. Functionally equivalent apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

What is claimed is:

1. A dual-network splitter, comprising:
an input port configured to transmit and receive signals in a first frequency band;
one or more dual-network output ports configured to transmit and receive the signals in the first frequency band and signals in a second frequency band;
one or more single-network output ports configured to transmit and receive the signals in the second frequency band;
a first splitter connected to the input port and configured to have the signals in the first frequency band pass therethrough;
a second splitter connected to the first splitter and configured to have the signals in the first frequency band pass therethrough;
a first dual-network filter connected to the first splitter and to a first of the dual-network output ports, wherein the first dual-network filter is configured to transmit the signals in the first and second frequency bands to the first of the dual-network output ports and to receive the signals in the first and second frequency bands from the first of the dual-network output ports, and wherein the first dual-network filter is configured to transmit the signals in the first frequency band to the first splitter and to receive the signals in the first frequency band from the first splitter;
a second dual-network filter connected to the second splitter and to a second of the dual-network output ports, wherein the second dual-network filter is configured to transmit the signals in the first and second frequency bands to the second of the dual-network output ports and to receive the signals in the first and second frequency bands from the second of the dual-network output ports, and wherein the second dual-network filter is configured to transmit the signals in the first frequency band to the second splitter and to receive the signals in the first frequency band from the second splitter;
a third dual-network filter connected to the second splitter and to a third of the dual-network output ports, wherein the third dual-network filter is configured to transmit the signals in the first and second frequency bands to the third of the dual-network output ports and to receive the signals in the first and second frequency bands from the third of the dual-network output ports, and wherein the third dual-network filter is configured to transmit the signals in the first frequency band to the second splitter and to receive the signals in the first frequency band from the second splitter; and
a third splitter connected to the first dual-network filter, the second dual-network filter, the third dual-network filter, and the one or more single-network output ports, wherein the third splitter is configured to have the signals in the second frequency band pass therethrough.

2. The dual-network splitter of claim 1, wherein the first dual-network filter comprises:
a low-pass filter configured to allow the signals in the first frequency band to pass therethrough, and to prevent the signals in the second frequency band from passing therethrough;
a fourth splitter connected to the low-pass filter; and
a high-pass filter connected to the fourth splitter, wherein the high-pass filter is configured to allow the signals in the second frequency band to pass therethrough, and to prevent the signals in the first frequency band from passing therethrough, and wherein the high-pass filter has a lower order than the low-pass filter.

3. The dual-network splitter of claim 1, wherein the first dual-network filter comprises:
a first low-pass filter configured to allow the signals in the first frequency band to pass therethrough, and to prevent the signals in the second frequency band from passing therethrough;
a fourth splitter connected to the first low-pass filter, wherein the fourth splitter comprises a second low-pass filter in an isolation path thereof;
a fifth splitter connected to the fourth splitter; and
a high-pass filter connected to the fifth splitter, wherein the high-pass filter is configured to allow the signals in the second frequency band to pass therethrough, and to prevent the signals in the first frequency band from passing therethrough.

4. The dual-network splitter of claim 1, wherein the first dual-network filter comprises:
a first low-pass filter configured to allow the signals in the first frequency band to pass therethrough, and to prevent the signals in the second frequency band from passing therethrough;
a fourth splitter connected to the low-pass filter, wherein the fourth splitter comprises a second low-pass filter in an isolation path thereof, and wherein the second low-pass filter has a lower order than the first low-pass filter; and
a high-pass filter connected to the fourth splitter, wherein the high-pass filter is configured to allow the signals in the second frequency band to pass therethrough, and to prevent the signals in the first frequency band from passing therethrough.

5. The dual-network splitter of claim 1, wherein the first dual-network filter comprises a diplex filter comprising a low-pass filter and a high-pass filter, wherein the low-pass filter is configured to allow the signals in the first frequency band to pass therethrough, and to prevent the signals in the second frequency band from passing therethrough, and wherein the high-pass filter is configured to allow the signals in the second frequency band to pass therethrough, and to prevent the signals in the first frequency band from passing therethrough.

6. A dual-network splitter, comprising:
an input port configured to transmit and receive signals in a first frequency band;
one or more dual-network output ports configured to transmit and receive the signals in the first frequency band and signals in a second frequency band; and
one or more single-network output ports configured to transmit and receive the signals in the second frequency band but not in the first frequency band.

7. The dual-network splitter of claim 6, wherein the input port is not configured to transmit and receive the signals in the second frequency band.

8. The dual-network splitter of claim 6, further comprising:
a diplex filter comprising a low-pass filter, a high-pass filter, and a common port, wherein the low-pass filter is connected to the input port;
a first splitter connected to the common port of the diplex filter and to a first of the one or more dual-network output ports; and
a second splitter connected to the high-pass filter of the diplex filter and to the one or more single-network output ports.

9. The dual-network splitter of claim 6, further comprising:
a low-pass filter connected to the input port; and
a dual-network filter connected to the low-pass filter and to a first of the one or more dual-network output ports, wherein the dual-network filter is configured to transmit the signals in the first frequency band to the low-pass filter and to receive the signals in the first frequency band from the low-pass filter, and wherein the dual-network filter is configured to transmit the signals in the first and second frequency bands to the first of the one or more dual-network output ports and to receive the signals in the first and second frequency bands from the first of the one or more dual-network output ports.

10. The dual-network splitter of claim 9, further comprising a splitter connected to the dual-network filter and to the one or more single-network output ports, wherein the dual-network filter is configured to transmit the signals in the second frequency band to the splitter and to receive the signals in the second frequency band from the splitter.

11. The dual-network splitter of claim 6, further comprising:
a first low-pass filter connected to the input port; and
a first splitter connected to the first low-pass filter and to a first of the one or more dual-network output ports, wherein the first splitter has a second low-pass filter in an isolation path thereof.

12. The dual-network splitter of claim 11, further comprising a second splitter connected to the first splitter and to the one or more single-network output ports, wherein the second splitter is configured to have the signals in the second frequency band pass therethrough.

13. The dual-network splitter of claim 6, further comprising:
a low-pass filter connected to the input port; and
a first splitter connected to the low-pass filter and to a first of the one or more dual-network output ports, wherein the first splitter has a low-pass filter in an isolation path thereof.

14. The dual-network splitter of claim 13, further comprising:
a high-pass filter connected to the low-pass filter and to a first of the dual-network output ports; and
a second splitter connected to the high-pass filter and to the one or more single-network output ports.

15. The dual-network splitter of claim 6, further comprising:
a first splitter connected to the input port;
a diplex filter connected to the first splitter and to a first of the one or more dual-network output ports; and
a second splitter connected to the diplex filter and to the one or more single-network output ports.

16. A dual-network splitter, comprising:
an input port configured to transmit and receive signals in a first frequency band but not in a second frequency band;
one or more dual-network output ports configured to transmit and receive the signals in the first frequency band and the signals in the second frequency band;
one or more single-network output ports configured to transmit and receive the signals in the second frequency band but not in the first frequency band;
a first splitter connected to the input port and configured to have the signals in the first frequency band pass therethrough;
a second splitter connected to the first splitter and configured to have the signals in the first frequency band pass therethrough; and
a third splitter connected to the first splitter, the second splitter, and the one or more single-network output ports, wherein the third splitter is configured to have the signals in the second frequency band pass therethrough.

17. The dual-network splitter of claim 16, further comprising a dual-network filter connected to a first of the dual-network output ports, the first splitter, and the third splitter, wherein the dual-network filter is configured to transmit the signals in the first and second frequency bands to the first of the dual-network output ports and to receive the signals in the first and second frequency bands from the first of the dual-network output ports, and wherein the dual-network filter is configured to transmit the signals in the first frequency band to the first splitter and to receive the signals in the first frequency band from the first splitter.

18. The dual-network splitter of claim 16, further comprising a dual-network filter connected to a second of the dual-network output ports, the second splitter, and the third splitter, wherein the dual-network filter is configured to transmit the signals in the first and second frequency bands to the second of the dual-network output ports and to receive the signals in the first and second frequency bands from the second of the dual-network output ports, and wherein the dual-network filter is configured to transmit the signals in the first frequency band to the second splitter and to receive the signals in the first frequency band from the second splitter.

19. The dual-network splitter of claim 16, further comprising a dual-network filter connected to a third of the dual-network output ports, the second splitter, and the third splitter, wherein the dual-network filter is configured to transmit the signals in the first and second frequency bands to the third of the dual-network output ports and to receive the signals in the first and second frequency bands from the third of the dual-network output ports, and wherein the dual-network filter is configured to transmit the signals in the first frequency band to the second splitter and to receive the signals in the first frequency band from the second splitter.

20. The dual-network splitter of claim 16, wherein:
the first splitter is not configured to have the signals in the second frequency band pass therethrough;
the second splitter is not configured to have the signals in the second frequency band pass therethrough; and
the third splitter is not configured to have the signals in the first frequency band pass therethrough.
